(19) United States
(12) Patent Application Publication
(10) Pub. No.: US 2026/0318414 A1
(43) Pub. Date: Oct. 15, 2026

(54) PERFORMANCE-CONTROLLABLE MECHANICAL SEALING DEVICE

(71) Applicant: TSINGHUA UNIVERSITY, Beijing (CN)

(72) Inventors: Weifeng HUANG, Beijing (CN); Qiang HE, Beijing (CN); Fengming HU, Beijing (CN); Ying LIU, Beijing (CN)

(21) Appl. No.: 19/685,143

(22) Filed: May 22, 2026

Related U.S. Application Data
(63) Continuation of application No. PCT/CN2024/127036, filed on Oct. 24, 2024.

(30) Foreign Application Priority Data
Dec. 1, 2023 (CN) 202311634584.3

(51) Int. Cl. F16J 15/3268

(52) U.S. Cl. CPC F16J 15/3268

(57) ABSTRACT

Provided is a performance-controllable mechanical sealing device. The mechanical sealing device includes a rotating ring, a shaft sleeve, an O-ring seal, and an adjustment ring. The rotating ring is mounted at the shaft sleeve. The shaft sleeve has a protruding ring. The protruding ring has a sealing groove at a side surface of the protruding ring adjacent to a back surface of the rotating ring. The O-ring seal is disposed in the sealing groove to seal a gap between the side surface of the protruding ring and a back part of the rotating ring. The adjustment ring is disposed in the sealing groove and nested with the O-ring seal to adjust a position of a high-low pressure demarcation point at the back surface of the rotating ring.

### CROSS-REFERENCE TO RELATED APPLICATION

This application is a continuation of International Application No. PCT/CN2024/127036, filed on Oct. 24, 2024, which is based on and claims priority to Chinese patent application No. 202311634584.3, filed on Dec. 1, 2023, the entire contents of which are incorporated herein by reference.

### FIELD

The present disclosure relates to the field of fluid sealing technologies, and more particularly, to a performance-controllable mechanical sealing device.

### BACKGROUND

A mechanical seal, serving as a shaft end seal for a rotating mechanical apparatus, is widely used in fields such as petrochemical, nuclear energy, and aerospace. The mechanical seal can operate under high parameter conditions, effectively preventing medium leakage, and ensuring a normal operation of the apparatus.

End face pressure distribution, temperature distribution, and deformation of the mechanical seal have a direct influence on performance and a service life of the seal. An inappropriate sealing structure design may lead to unexpected sealing performance, resulting in excessive friction and wear on the end face, and thus accelerating aging and damage of the seal. Therefore, ensuring rationality of a mechanical sealing structure design is of great significance for improving the performance and the service life of the mechanical seal. In practical applications, the performance of the mechanical seal can be effectively improved by optimizing a structure and materials of the mechanical seal, and by adopting reasonable operation methods and maintenance measures.

An existing sealing structure design usually adopts a forward design mode. That is, in a design stage, multi-field coupling calculation is performed on operation capacity of the seal. A final parameter range of the operation capacity of a sealing end face under actions of a flow field, a thermal field, and a deformation field is calculated, and then a structural parameter is continuously revised and optimized through experiments, to obtain a sealing design that can meet operating condition requirements. However, when external operating conditions change significantly and the sealing structure ages, an original sealing structure design may be difficult to effectively adjust the sealing performance and thus fail to continue meeting the requirements.

### SUMMARY

The present disclosure aims to solve at least one of the technical problems in the related art. To this end, an objective of the present disclosure is to provide a performance-controllable mechanical sealing device, which can effectively adjust sealing performance of a designed mechanical sealing device to meet sealing requirements of the mechanical sealing device and enable the mechanical sealing device to be applied under various operating conditions.

The performance-controllable mechanical sealing device according to the embodiments of the present disclosure includes a rotating ring, a shaft sleeve, an O-ring seal, and an adjustment ring. The rotating ring is mounted at the shaft sleeve. The shaft sleeve has a protruding ring. The protruding ring has a sealing groove at a side surface of the protruding ring adjacent to a back surface of the rotating ring. The O-ring seal is disposed in the sealing groove to seal a gap between the side surface of the protruding ring and a back part of the rotating ring. The adjustment ring is disposed in the sealing groove and nested with the O-ring seal to adjust a position of a high-low pressure demarcation point at the back surface of the rotating ring.

The performance-controllable mechanical sealing device according to the embodiments of the present disclosure can effectively adjust the sealing performance of the designed mechanical sealing device by adjusting the position of the high-low pressure demarcation point between the O-ring seal and the rotating ring through the adjustment ring, enabling the performance-controllable mechanical sealing device to be applied under various operating conditions, meeting the sealing requirements of the mechanical sealing device, and avoiding or delaying leakage issues caused by performance degradation of the sealing device. Thus, safe operation of an apparatus using the performance-controllable mechanical sealing device is ensured, a service life of the apparatus using the performance-controllable mechanical sealing device is prolonged, and reliability and economic benefits of the apparatus using the performance-controllable mechanical sealing device are improved.

In some embodiments, the adjustment ring is tightly nested at a radially outer end of the O-ring seal and/or a radially inner end of the O-ring seal.

In some embodiments, the position of the high-low pressure demarcation point varies within a range of 0 mm to 0.5 mm.

In some embodiments, the adjustment ring is made of a hard material.

In some embodiments, the position of the high-low pressure demarcation point is adjusted by selecting the adjustment ring with different radial dimensions to be nested at a radially outer end of the O-ring seal or a radially inner end of the O-ring seal.

In some embodiments, when the adjustment ring is nested at a radially outer end of the O-ring seal, an inner side surface of the adjustment ring is cylindrical; and when the adjustment ring is nested at a radially inner end of the O-ring seal, an outer side surface of the adjustment ring is cylindrical.

In some embodiments, the adjustment ring is made of a deformable material. The position of the high-low pressure demarcation point is adjusted by on-line adjustment of a dimension of the adjustment ring.

In some embodiments, the deformable material is piezoelectric ceramic.

In some embodiments, a cross-section of the sealing groove is rectangular.

Additional aspect and advantages of the present disclosure will be provided in part in the following description, or will in part become apparent from the following description, or be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic view of an overall structure of a performance-controllable mechanical sealing device according to an embodiment of the present disclosure.

FIG. 2 is a schematic structural view of a partially enlarged part in FIG. 1, showing an adjustment ring nested at a radially outer end of an O-ring seal.

FIG. 3 is a schematic view showing an adjustment ring nested at a radially inner end of an O-ring seal.

Reference numerals of the accompanying drawings: performance-controllable mechanical sealing device 1000; rotating ring 100; shaft sleeve 200; protruding ring 201; sealing groove 2011; O-ring seal 300; adjustment ring 400; stationary ring 500; thrust ring 600; spring 700; auxiliary sealing structure 800; stationary ring seat 900; sleeve 110; shaft 120.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

A performance-controllable mechanical sealing device 1000 according to the embodiments of the present disclosure will be described below in conjunction with FIG. 1 to FIG. 3.

As illustrated in FIG. 1 to FIG. 3, the performance-controllable mechanical sealing device 1000 according to the embodiments of the present disclosure includes a rotating ring 100, a shaft sleeve 200, an O-ring seal 300, and an adjustment ring 400. The rotating ring 100 is mounted at the shaft sleeve 200. The shaft sleeve 200 has a protruding ring 201. The protruding ring 201 has a sealing groove 2011 at a side surface of the protruding ring 201 adjacent to a back surface of the rotating ring 100. The O-ring seal 300 is disposed in the sealing groove 2011 to seal a gap between the side surface of the protruding ring 201 and a back part of the rotating ring 100. The adjustment ring 400 is disposed in the sealing groove 2011 and nested with the O-ring seal 300 to adjust a position of a high-low pressure demarcation point at the back surface of the rotating ring 100.

In some embodiments, the rotating ring 100 is mounted at the shaft sleeve 200, and is fixedly connected to a shaft 120 through the shaft sleeve 200 and a sleeve 110. That is, the rotating ring 100 can rotate along with the shaft 120. A stationary ring 500 is disposed at a side of the rotating ring 100, and floatingly supported on a stationary ring seat 900 by means of a thrust ring 600, a spring 700 and an auxiliary sealing structure 800. Although non-rotating, the stationary ring 500 is floatable, which can maintain a relatively stable relative movement relationship between an end face of the stationary ring 500 and an end face of the rotating ring 100 under various forces, thus preventing an excessively large gap or an excessively small gap between the end face of the rotating ring 100 and the end face of the stationary ring 500. The excessively large gap between the end face of the rotating ring 100 and the end face of the stationary ring 500 may result in excessively large leakage of the performance-controllable mechanical sealing device 1000; and the excessively small gap between the end face of the rotating ring 100 and the end face of the stationary ring 500 may cause the stationary ring 500 and the rotating ring 100 to come into contact with each other, thereby leading to rapid damage and shortening a service life of the rotating ring 100 and a service life of the stationary ring 500.

The performance-controllable mechanical sealing device 1000 achieves rotary sealing through a friction pair formed between the hard-material rotating ring 100 and the soft-material stationary ring 500 during rotation. The friction pair between the rotating ring 100 and the stationary ring 500 has certain rigidity. That is, as a relative position between the rotating ring 100 and the stationary ring 500 changes, an acting force exerted by the friction pair on the stationary ring 500 may vary to resist such change, to maintain the relatively stable relative movement relationship between the end face of the stationary ring 500 and the end face of the rotating ring 100, ensuring the sealing performance of the performance-controllable mechanical sealing device 1000.

Since a traditional sealing structure can only satisfy operating conditions required by an initial design once finalized, to continuously adjust performance of the traditional sealing structure to adapt to multiple operating conditions, the protruding ring 201 of the shaft sleeve 200 in the embodiments of the present disclosure has the sealing groove 2011 at the side surface of the protruding ring 201 adjacent to the back surface of the rotating ring 100. The O-ring seal 300 is disposed in the sealing groove 2011, and two axial ends of the O-ring seal 300 are in contact with the rotating ring 100 and the protruding ring 201, respectively. A contact position between the O-ring seal 300 and the rotating ring 100 serves as the high-low pressure demarcation point, with a radially outer side of the rotating ring 100 being a high-pressure side and a radially inner side of the rotating ring 100 being a low-pressure side.

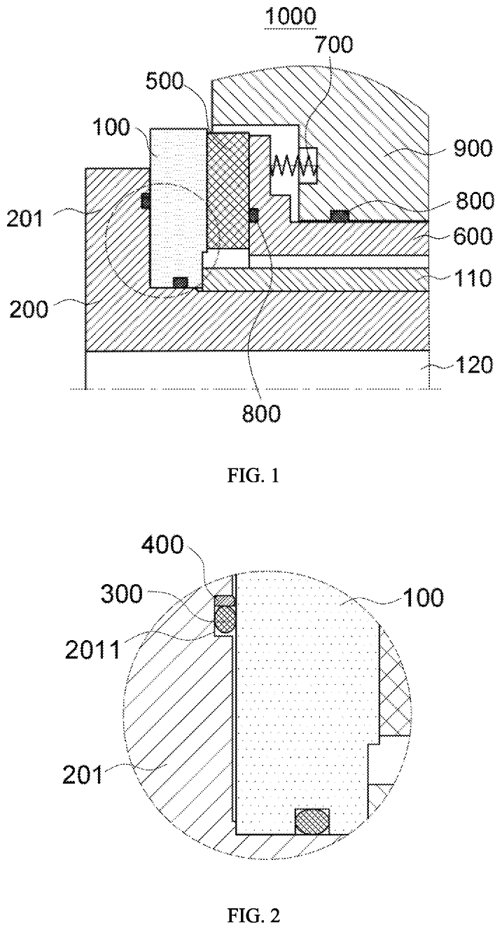

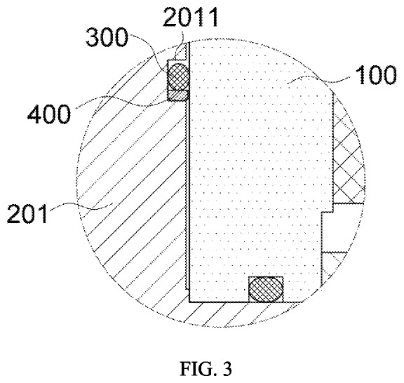

The adjustment ring 400 is disposed in the sealing groove 2011 and nested with the O-ring seal 300, for example, the adjustment ring 400 is nested at the radially inner side of the O-ring seal 300 (as illustrated in FIG. 3) or at the radially outer side of the O-ring seal 300 (as illustrated in FIG. 2), to adjust the position of the high-low pressure demarcation point at the back surface of the rotating ring 100. That is, the adjustment ring 400 can adjust a radial position of the O-ring seal 300, changing a position of a contact point between the O-ring seal 300 and the rotating ring 100, thus changing the position of the high-low pressure demarcation point at the back surface of the rotating ring 100, and achieving effective adjustment of the sealing performance of the performance-controllable mechanical sealing device 1000. When the sealing performance of the performance-controllable mechanical sealing device 1000 needs to be adjusted, the position of the high-low pressure demarcation point is adjusted by changing a radial dimension of the adjustment ring 400, for example, by selecting and replacing a hard adjustment ring 400 with different radial dimensions to nest the adjustment ring 400 at a radially outer end or a radially inner end of the O-ring seal 300; or by on-line adjusting the radial dimension of a deformable adjustment ring 400 to squeeze the O-ring seal 300, thus causing a radial displacement of the O-ring seal 300 and causing the contact point between the O-ring seal 300 and the rotating ring 100 and the high-low pressure demarcation point to shift radially along the back surface of the rotating ring 100. A change in pressure on the back part of the rotating ring 100 may change a magnitude of a closing force of a sealing end face. To achieve dynamic equilibrium, a thickness of a sealing fluid film may change, leading to variation in pressure distribution across the sealing end face and further causing deformation of the sealing end face. Such deformation of the sealing end face results in changes in fluid shear heating and solid shear heating on the sealing end face, and in turn affects the pressure distribution on the sealing end face. The above process repeats continuously until a new equilibrium state is finally reached, thus achieving a purpose of regulating the sealing performance, and meeting the requirements of multiple operating conditions.

The performance-controllable mechanical sealing device 1000 according to the embodiments of the present disclosure can effectively adjust sealing performance of a designed mechanical sealing device by adjusting the position of the high-low pressure demarcation point between the O-ring seal and the rotating ring through the adjustment ring, enabling the performance-controllable mechanical sealing device 1000 to be applied under various operating conditions, meeting sealing requirements of the mechanical sealing device, and avoiding or delaying leakage issues caused by performance degradation of the sealing device. Thus, safe operation of an apparatus using the performance-controllable mechanical sealing device 1000 is ensured, a service life of the apparatus using the performance-controllable mechanical sealing device 1000 is prolonged, and reliability and economic benefits of the apparatus using the performance-controllable mechanical sealing device 1000 are improved.

In some embodiments, the adjustment ring 400 is tightly nested at the radially outer end of the O-ring seal 300 and/or the radially inner end of the O-ring seal 300.

In some embodiments, when the adjustment ring 400 is tightly nested at the radially outer end of the O-ring seal 300, the O-ring seal 300 can be tightly clamped, thus changing the radial position of the O-ring seal 300. The contact point between the O-ring seal 300 and the rotating ring 100, which is also the high-low pressure demarcation point, may shift radially inward. The change in the pressure on the back part of the rotating ring 100 may change the pressure distribution across the sealing end face, which in turn causes the deformation of the sealing end face. Such deformation of the sealing end face results in the changes in the fluid shear heating and the solid shear heating on the sealing end face, and in turn affects the pressure distribution on the sealing end face. The above process repeats continuously until the new equilibrium state is finally reached, thus achieving the purpose of regulating the sealing performance of the performance-controllable mechanical sealing device 1000.

When the adjustment ring 400 is tightly nested at the radially inner end of the O-ring seal 300, the O-ring seal 300 can be expanded, thus changing the radial position of the O-ring seal 300. The contact point between the O-ring seal 300 and the rotating ring 100, which is also the high-low pressure demarcation point, may shift radially outward. The change in the pressure on the back part of the rotating ring 100 may change the pressure distribution across the sealing end face, which in turn causes the deformation of the sealing end face. Such deformation of the sealing end face results in the changes in the fluid shear heating and the solid shear heating on the sealing end face, and in turn affects the pressure distribution on the sealing end face. The above process repeats continuously until the new equilibrium state is finally reached, thus achieving the purpose of regulating the sealing performance of the performance-controllable mechanical sealing device 1000.

In some embodiments, the position of the high-low pressure demarcation point varies within a range of 0 mm to 0.5 mm. Since the high-low pressure demarcation point has a significant influence on the sealing performance, the position variation of the high-low pressure demarcation point in a range of 0 mm to 0.5 mm enables the performance-controllable mechanical sealing device 1000 to achieve expected sealing performance.

In some embodiments, the adjustment ring 400 is made of a hard material to ensure structural strength of the adjustment ring 400. Thus, the O-ring seal 300 is effectively expanded or compressed by the adjustment ring 400, ensuring effectiveness of adjustment capability of the adjustment ring 400. Meanwhile, the adjustment ring 400 can be prevented from being damaged by a pressure on the high-pressure side or damaged by the expansion of the O-ring seal 300 when nested at the radially outer end of the O-ring seal 300. Also, the adjustment ring 400 can be prevented from being damaged by the pressure on the high-pressure side and compression of the O-ring seal 300 when nested at the radially outer end of the O-ring seal 300.

In some embodiments, the position of the high-low pressure demarcation point is adjusted by selecting the adjustment ring 400 with different radial dimensions to be nested at the radially outer end of the O-ring seal 300 or the radially inner end of the O-ring seal 300. That is, the radial position of the O-ring seal 300 can be changed by replacing the adjustment ring 400 with different radial dimensions, to change the position of the high-low pressure demarcation point at the back part of the rotating ring 100 and ensure that the performance-controllable mechanical sealing device 1000 achieves the expected sealing performance.

In some embodiments, when the adjustment ring 400 is nested at the radially outer end of the O-ring seal 300, an inner side surface of the adjustment ring 400 is cylindrical; and when the adjustment ring 400 is nested at the radially inner end of the O-ring seal 300, an outer side surface of the adjustment ring 400 is cylindrical. That is, a side of the adjustment ring 400 that is in contact with the O-ring seal 300 is cylindrical and matches with a shape of the O-ring seal 300, which facilitates mounting the adjustment ring 400 at the O-ring seal 300.

In some embodiments, the adjustment ring 400 is made of a deformable material. The position of the high-low pressure demarcation point is adjusted by on-line adjustment of a dimension of the adjustment ring 400.

In some embodiments, when the adjustment ring 400 made of the deformable material is used, the adjustment ring 400 may be mounted at the radially outer end of the O-ring seal 300 or/and the radially inner end of the O-ring seal 300. When the sealing performance needs to be adjusted, the radial dimension of the adjustment ring 400 may be adjusted on-line to change the position of the high-low pressure demarcation point, which can avoid replacement of the adjustment ring 400 with other radial dimensions and achieve high adjustment efficiency. When the adjustment ring 400 made of the deformable material is mounted at both the radially outer end of the O-ring seal 300 and the radially inner end of the O-ring seal 300 at the same time, the adjustment ring 400 may be adjusted on-line to adjust the O-ring seal 300 from both the radially outer end and the radially inner end, thus achieving a favorable adjustment effect and high adjustment efficiency.

In some embodiments, the deformable material is piezoelectric ceramics. That is, using the piezoelectric ceramic to fabricate the adjustment ring 400 allows for on-line adjustment of the dimension of the adjustment ring 400, causing the radial displacement of the O-ring seal 300, changing the position of the high-low pressure demarcation point, and achieving on-line adjustment of the sealing performance of the performance-controllable mechanical sealing device 1000.

In some embodiments, a cross-section of the sealing groove 2011 is rectangular, which facilitates machining, and facilitates mounting of the O-ring seal 300 and the adjustment ring 400.

Reference throughout this specification to “an embodiment”, “some embodiments”, “schematic embodiments”, “an example”, “a specific example”, or “some examples” means that a particular feature, structure, or characteristic described in connection with the embodiment or example is included in at least one embodiment or example of the present disclosure. In this specification, exemplary descriptions of above terms are not necessarily referring to the same embodiment or example. Further, the particular features, structures, or characteristics can be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A performance-controllable mechanical sealing device, comprising:
a rotating ring;
a shaft sleeve, wherein the rotating ring is mounted at the shaft sleeve, the shaft sleeve having a protruding ring, and the protruding ring having a sealing groove at a side surface of the protruding ring adjacent to a back surface of the rotating ring;
an O-ring seal disposed in the sealing groove to seal a gap between the side surface of the protruding ring and a back part of the rotating ring; and
an adjustment ring disposed in the sealing groove and nested with the O-ring seal to adjust a position of a high-low pressure demarcation point at the back surface of the rotating ring.

2. The performance-controllable mechanical sealing device according to claim 1, wherein the adjustment ring is tightly nested at a radially outer end of the O-ring seal and/or a radially inner end of the O-ring seal.

3. The performance-controllable mechanical sealing device according to claim 1, wherein the position of the high-low pressure demarcation point varies within a range of 0 mm to 0.5 mm.

4. The performance-controllable mechanical sealing device according to claim 1, wherein the adjustment ring is made of a hard material.

5. The performance-controllable mechanical sealing device according to claim 1, wherein the position of the high-low pressure demarcation point is adjusted by selecting the adjustment ring with different radial dimensions to be nested at a radially outer end of the O-ring seal or a radially inner end of the O-ring seal.

6. The performance-controllable mechanical sealing device according to claim 1, wherein:
when the adjustment ring is nested at a radially outer end of the O-ring seal, an inner side surface of the adjustment ring is cylindrical; and
when the adjustment ring is nested at a radially inner end of the O-ring seal, an outer side surface of the adjustment ring is cylindrical.

7. The performance-controllable mechanical sealing device according to claim 1, wherein:
the adjustment ring is made of a deformable material; and
the position of the high-low pressure demarcation point is adjusted by on-line adjustment of a dimension of the adjustment ring.

8. The performance-controllable mechanical sealing device according to claim 7, wherein the deformable material is piezoelectric ceramic.

9. The performance-controllable mechanical sealing device according to claim 1, wherein a cross-section of the sealing groove is rectangular.
